(19) United States
(12) Patent Application Publication
(10) Pub. No.: US 2012/0012058 A1
(43) Pub. Date: Jan. 19, 2012

(54) Infusion moulded platforms and components thereof

(76) Inventors: Joshua Wayne Janmaat, Morrinsville (NZ); Michael David Bates, Auckland (NZ)

(21) Appl. No.: 13/067,628

(22) Filed: Jun. 15, 2011

Related U.S. Application Data
(63) Continuation-in-part of application No. 13/127,332, filed on Jul. 19, 2011.

(30) Foreign Application Priority Data
Nov. 3, 2008 (NZ) 572534
Jun. 15, 2010 (NZ) 586171
Dec. 15, 2010 (NZ) 589980

(51) Int. Cl. A01J 5/003; A01J 5/00

(52) U.S. Cl. 119/14.04

(57) ABSTRACT

A moulded module for a rotary milking platform comprising or including a core of filler material (for example foamed plastics) surrounded by layers of fibre reinforced materials and optionally also with steel reinforcements, all components having been applied in-mould.

The present invention relates to an infusion moulded platform component suitable for us as part of a milking platform, related facilities and uses as disclosed in our unpublished NZ Patent Application No 572534.

Milking platforms of rotary milking facilities tend to be metal platforms or concrete topped metal platforms. They may run about a central pivot or be tracked, or both.

The present invention and the earlier invention of NZ572534 recognises that speed of erection can be obtained by providing moulded components (particularly of a composite material) for use in the erection of the platform of a milking facility. This is particularly so where each moulded component, to form part of a substantially annular platform, defines a plural sequence of bail floors or parts thereof.

The present invention also, or in addition, sees an advantage from being able to provide componentary of a platform able to be assembled onto a sub-frame and/or to each other and/or so as to relate to each other as a substantially continuous annulus.

The present invention also, or in addition, sees an advantage in the use of light weight componentary able to be readily transported (eg, in a typical shipping container) yet able to be speedily assembled to provide a long service life rotary milking platform.

It is also in accordance with certain aspect of the present invention considered desirable to provide a “feel” providing surface for milking animals of a floor formed from modular components (for example of composite materials able to be moulded to a shape), the feel being provided by (1) attached and/or inlaid resilient material(s) and/or (2) fully or partly embedded filler or core material(s).

It is an object of the present invention to provide an alternative to the primarily steel and/or steel and concrete rotary milking platforms and/or to provide an improvement in or addition to the invention of NZ572534.

It is a further, or alternative, object of the present invention to provide moulded modules (involving composite material(s) and embedded metal support or other members) useful when assembled in defining a rotary milking platform (whether on a sub-frame or not), and a milking facility having moulded floor defining components (involving composite material(s) and embedded metal supports or other members) and related methods and procedures.

It is a further or alternative object to provide a metal insert in mould on fibres and/or a RTM spacer for in mould total or partial envelopment together with other inserted material (eg. glass fibres, aramid or para-aramid fibres, foam, etc).

In an aspect the invention is a resin infusion moulded rotary milking platform deck component or module having a foam plastics core,

at least one layer of glass fibre on each side of the foam core, and

at least one layer of an aramid or para-aramid strand or fibrous material adjacent the foam plastics core, interposed in glass fibre layers and/or disposed outwardly of the glass fibre layer(s).

In an aspect the invention is a resin infusion moulded rotary milking platform deck component or module having

a foam plastics core,

at least one layer of glass fibre on each side of the foam core, and

at least one layer of an aramid or para-aramid strand or fibrous material adjacent the foam plastics core, interposed in glass fibre layers and/or disposed outwardly of the glass fibre layer(s)

wherein in mould or post mould there is an embedding of at least one structural support or other member of a metal.

In another aspect the invention is a resin infusion moulded rotary milking platform deck component or module having embedded in the resin matrix

plural layers of glass fibre, and

at least one layer of an aramid or para-aramid strand or fibrous material

wherein in mould, or post mould, there is an embedding in the or in a fibre reinforced resin matrix of at least one structural support or other member of a metal.

Optionally the metal is of substantially an elongate (straight, arcuate or other) form, hollow or not [preferably of box section or of ‘I’ section], preferably of steel, and preferably provide transverse and/or radial support of the component or module. Or it is an insert to provide zonal support for fabrication purposes (ie. as embedded anchors for posts, etc).

In an aspect the invention is a component or module to provide part of the annular floor structure of a rotary milking platform

wherein at least one metal member supported in mould by fibres and/or RTM form(s) and more expansive layers of fibres have been resin infusion embedded or resin infusion part embedded.

In another aspect the invention is a moulded module able to be associated with others on a rotatable support to define a rotary milking platform, the module being moulded at least in part in a composite material yet embedding both at least one structural support or other metallic member and a core of a foam material.

In another aspect the invention is a moulded module able to be associated with others on a rotatable support to define a rotary milking platform, the module being moulded at least in part in a composite material about and optionally at least one metallic member including one or more resilient material mats.

Preferably the composite material(s) include as an inlay or an imbedded core another material (eg, a foam or filler).

Preferably each module is to define at least part of the floor and/or mat support for a plurality of bails.

Preferably each module is provided with an inner and outer curved or facetted periphery (preferably circular or a continuous curve) and/or preferably the end peripheries are substantially radially aligned with respect to the axis of rotation of the to be defined rotary milking platforms.

In another aspect the invention is a rotary milking platform having a bail floor, or at least part of its floor and/or sub-floor if matted, formed at least in part from an infusion moulded component or modules of the present invention.

Preferably each module is to define at least part of the floor and/or mat support for a plurality of bails.

Preferably each module is provided with an inner and outer curved or facetted periphery (preferably circular or a continuous curve) and/or preferably the end peripheries are substantially radially aligned with respect to the axis of rotation of the to be defined rotary milking platforms.

In another aspect the invention is a rotary milking platform having a rotatable sub-floor frame and a floor defining assembly of infusion moulded platform components or modules of the present invention.

Preferably each module is to define at least part of the floor and/or mat support for a plurality of bails.

Preferably each module is provided with an inner and outer curved or facetted periphery (preferably circular or a continuous curve) and/or preferably the end peripheries are substantially radially aligned with respect to the axis of rotation of the to be defined rotary milking platforms.

In another aspect the invention is an infusion moulded floor module or component to define one or more bail floor of an annular milking platform

wherein at least one metal mass (eg. steel) has been in mould embedded by resin infused fibrous material(s) and/or at least one metal mass (eg. steel) has been post mould embedded by a composite material attaching to an infusion moulded part of the module or component.

The metal mass can be a rib but not be. It can be an anchoring zone for fabrication purposes.

In another aspect the invention is a milking facility that includes a walk-on/back-off entrance/exit arrangement to bails defined on a rotatable platform where the floor of the platform, optionally at least in part matted, is at least in part of components or modules of the present invention.

Preferably each module is provided with an inner and outer curved or facetted periphery (preferably circular or a continuous curve) and/or preferably the end peripheries are substantially radially aligned with respect to the axis of rotation of the to be defined rotary milking platforms.

In another aspect the invention is a rotary milking platform having a rotatable sub-floor frame and floor of infusion moulded components or modules as aforesaid carried thereby (optionally at least in part matted with a resilient material).

Preferably each module is provided with an inner and outer curved or facetted periphery (preferably circular or a continuous curve) and/or preferably the end peripheries are substantially radially aligned with respect to the axis of rotation of the to be defined rotary milking platforms.

In another aspect the invention is a milking facility that includes a walk-on/back-off entrance/exit arrangement to bails defined on a rotatable platform at least where the floor of the platform is at least in part of components or modules of the present invention.

Preferably each module is provided with an inner and outer curved or facetted periphery (preferably circular or a continuous curve) and/or preferably the end peripheries are substantially radially aligned with respect to the axis of rotation of the to be defined rotary milking platforms.

In another aspect the invention consists in a module for use as part of a milking platform, a rotary milking platform having such a module and/or a milking facility having such a platform with such modules;

wherein each module defining one or more bail floor area (whether post mould matted, or not, or whether in mould matted, or not has been manufactured in a mould by resin infusion about a filling material (eg, a foam plastics material) and at least one metallic support or other member about at least part of which there has been positioned in mould the fibres to be embedded in the resin.

Preferably each module defines part of an annulus having plural bail floors defined.

Preferably the resin infusion defines a depressed region to be post mould matted.

Preferably the mouldings have any one or more of the characteristics herein described with or without reference to any one or more of the accompanying drawings.

In another aspect the invention is a rotary milking platform having an annular platform floor (each bail being or to be optionally matted fully or in part) defined by an assembly of moulded floor defining components of composite material in mould or post mould embedding at least one metallic support or other member, each defining part of, or all of, one or more bail floors.

In another aspect the invention is a rotary milking platform having an annular platform floor (optionally each bail being or to be optionally matted fully or in part) defined by an assembly of moulded composite material(s) floor defining components, each defining part of, or all of, one or more bail floors;

wherein each component is resin infusion moulded about at least one filler or core to provide an exoskeleton of a composite material;

and wherein at least one metallic support or other member is also embedded, whether in mould, or post mould by such composite material(s).

In still another aspect the invention is a rotary milking platform having an annular platform floor, each bail being or to be matted fully or in part, the floor or sub floor being defined by an assembly of moulded floor defining components, each defining part of, or all of, one or more bail floors and each having a resin matrix reinforced by fibres embedding at least one metallic support or other member.

Preferably each moulded component is at least in part (and preferably wholly) provided with a composite material surround (eg, as if an exoskeletal surface providing surround about a filler or core providing material and the metallic member(s)). Most preferably the moulding is by a process of infusion moulding with a composite system (eg, a resin system without fibre or a resin system including fibre) into cavities about one or more filler or core providing material (eg, a foam, a blow moulded foam, an expanded form or the like), optionally, in conjunction with in mould positioned fibres and the to be embedded metallic member(s) resulting in the moulding that is at least in part of composite material(s).

In another aspect the invention is a moulded module now having in mould or post mould composite material embedded metallic support able to be associated with others on a rotatable support to define a rotary milking platform, the module including for its, or each, bail floor it is to fully or in part define, a leg spreading profile (integrally defined or subsequently added).

In another aspect the invention is a moulded module having in mould or post mould composite material embedded metallic support able to be associated with others on a rotatable support to define a rotary milking platform, the module including for its, or each, bail floor it is to fully or in part define, an udder spray site or sites.

In another aspect the invention is a rotary milking facility having a rotary platform with prefabricated or moulded profiled floor segments, each segment or most segments being a component or module of the present invention providing multiple substantially radially aligned stall floors, and at least one zone for entering onto an aligned stall and at least one zone for exiting from an aligned stall.

In another aspect the present invention consists in, in combination, moulded modules or modules as previously defined, optionally with or without any member or members of a support therefore.

Preferably said combination is part of a kit.

In a further aspect the invention consists in modules, individual bails, a rotary platform, a milking facility, and related methods of assembly and use, substantially as herein described with or without reference to any one or more of the accompanying drawings.

As used herein “metallic” or “metal” includes alloys or single metals. An example (preferred) is a suitable steel (elongate and hollow, solid or I sectioned) to provide an arcuate rib (aligned to the annulus and/or a rib to lie radially).

As used here in the term “composite material” or variations of it to a matrix or binder that binds together a reinforcement material or materials refers to materials typified by fibreglass but not restricted solely to fibreglass which incorporate a reinforcement fibre (whether as a mat or otherwise) imbedded in a surrounding matrix such as a suitable settable resin and/or polymeric material. Fibre reinforcement can be by way of long or short fibre lengths of glass Fibre, plastics material fibre (eg, KEVLAR™), carbon fibre, or the like. The sheets or mats can be chopped strand mats (CSM) or a woven fabric. Owens Corning FIBERGLAS™ sheets can be used.

Multiple mat types can be used in different layers. Preferably KEVLAR™ armours the structure under a gelcoat protected surface of the infusion moulding.

Preferably the composite material(s) is moulded preferably using a resin infusion moulding process. This involves a flowable matrix or binder being infused into the mould after fibre placement therein and/or after any other embeddable material or forms (optionally also the metallic support) is placed therein (eg, as a filler or core).

In some forms the moulding can provide the upper surface of the component or module onto which, resin and/or polymeric matrix can be laid up in order to embed the metallic support.

As used herein “resin” relates to any settable liquid or flowable matrix. Preferably it is a polymeric system.

The resin system preferably is a thermosetting unsaturated polyester system, a vinylester system or an epoxy system. Particularly preferred are a vinylester-epoxy profusion resins.

Gelcoats (e.g. as used in New Zealand marine or swimming pool applications) can be applied to exposed surfaces.

The resultant thickness of the floor is to withstand prolonged use and preferably is at least several millimetres thick with ample reinforcement embodied in the binding resin system to ensure the fibres take up all the expected tensile loads.

As used herein reference to “foamed or expanded plastics material” or “foamed or expanded polymeric material” preferably includes within its ambit any compatible singular or mix of materials that collectively provide a filler about which and at least in part into which the resin or other polymeric material can be infused to bind the reinforcing fibres suitable organic foam materials include those of polystyrene, polyurethane, polyisocyanurate and urea-formaldehyde. Other options are bound.

Preferably any foamed plastic or other material is preferably substantially rigid so as to provide little in the way of flexing under the exoskeletal moulded material eg, fibreglass. Of course other fillers including wood, or even flexible plastics materials (foamed or otherwise) can be used as the core or filling material.

Reference to a “mat or matted” surface or variation of it in conjunction with the moulded component preferably relates to a fitted, affixed and/or inlayed mat of, for example, a resilient synthetic or natural rubber (or other elastomeric material), optionally reinforced, typified, by way of example, by fibre or metal reinforced rubber belting material as used in conveyors. There is however less of an issue with the material needing to take tensile forces than is the case with a conveyor belt type material. Nevertheless the dairy usage as a mat to provide comfort for and reduce the noise by dairy cows on the platform does mean that preferably a strong material requiring infrequent replacement is utilised. Such a material as a mat protects the moulded surface that underlies the mat and which is not normally contacted by the animal's hooves.

As used herein to “bail” or “stall” should be considered as being interchangeable. Sometimes their usage refers to the area of floor required by an animal and in other uses or, as the context allows, relates to the (preferably separated) individual milking positions of the platform. The term “bail” or “stall” preferably does not include that area inwardly of where the animal is to stand, head inwards, which may be provided as a walkway to allow access about the platform to each animals head.

Reference herein to “ramps” or the like to allow ingress and/or egress from the platform does not necessarily require any inclination of the walkway. Nor does it require that the walkways be separate or singular. In some embodiments, there may be zones of bails or stalls each having their own entrance way and each having their own egress way.

It is preferred in accordance with the present invention that the animals walk head first into their bail or stall and exit by backing off the platform or at least out of the bail or stall area where they are milked to exit from the platform.

As used herein “annular”, “annulus” or variations of it include a shape, when viewed in plan, that may or may not have an inner periphery or an outer periphery as a smooth curve. Whilst both are preferably substantially circular, facetted options are included.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features, prefaced by that term in each statement, all need to be present but other features can also be present. Related terms such as “comprise” and “comprised” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

The entire disclosures of all applications, patents and publications, cited above and below, if any, are hereby incorporated by reference.

Preferred forms of the present invention will now be described with reference to the accompanying drawings in which

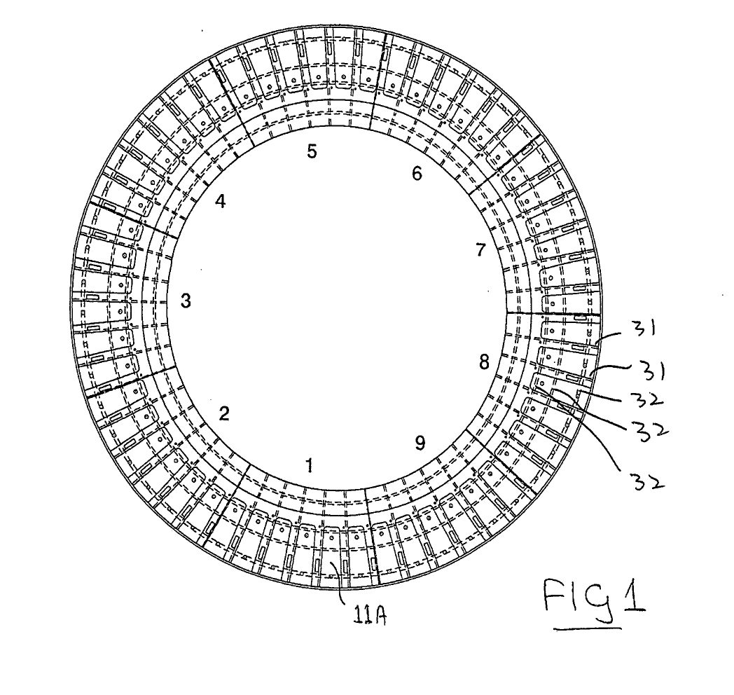

FIG. 1 is a plan view of a annular milking platform made up by nine prefabricated and/or moulded components (for example each to define 6 bail areas) to provide, by way of example, a 54 bail annular platform,

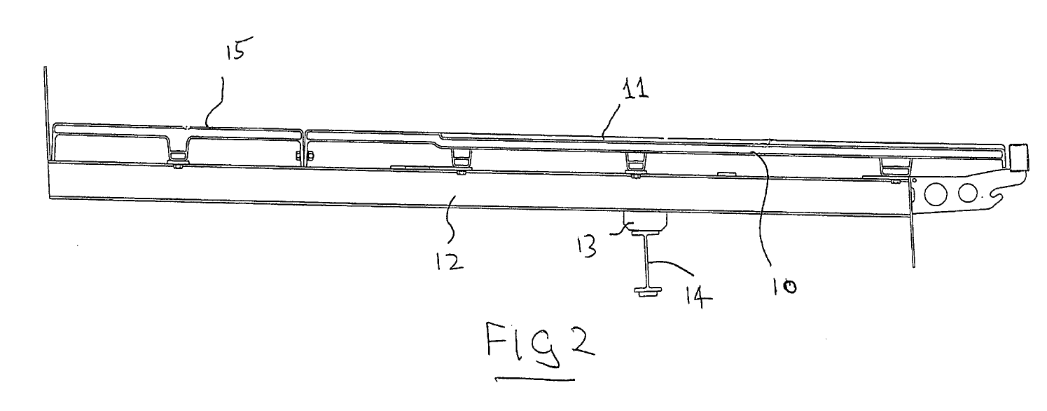

FIG. 2 is a sectional view looking transverse of the radial support preferred I Beam of a platform as in FIG. 1,

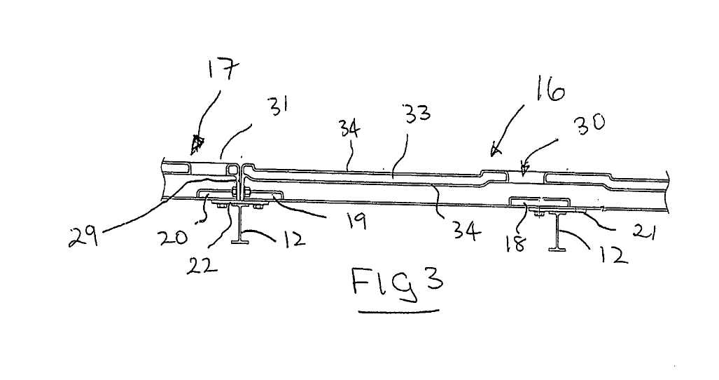

FIG. 3 is a radial view of a section of a platform as in FIGS. 1 and 2, the I Beams being shown end on or in section and showing over the left hand I Beam a mating to the sub-frame structure of adjacent moulded components,

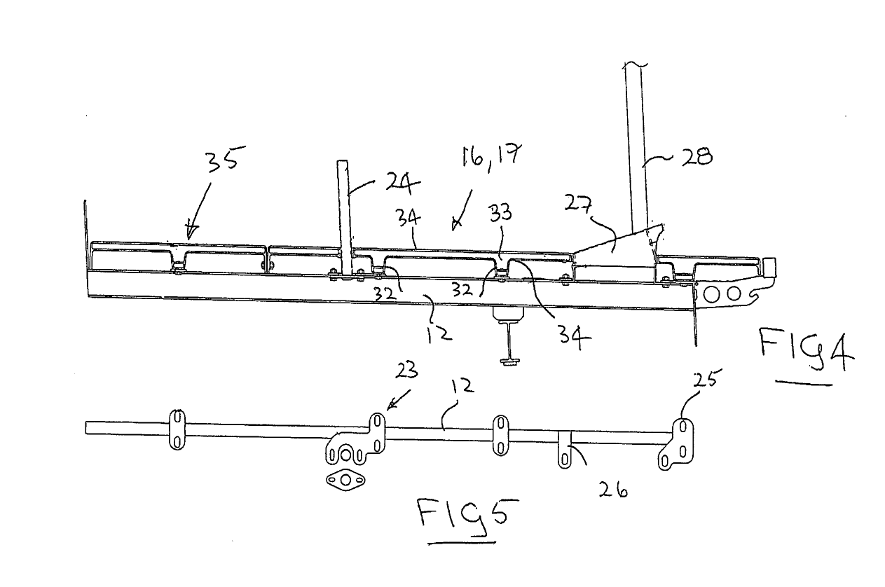

FIG. 4 is a view in a similar direction to that of FIG. 2 but rather than showing a section of the mouldings mid bail, instead showing the platform assembly at a point where a through platform port is shown and post members are supported directly or indirectly from the radial rib,

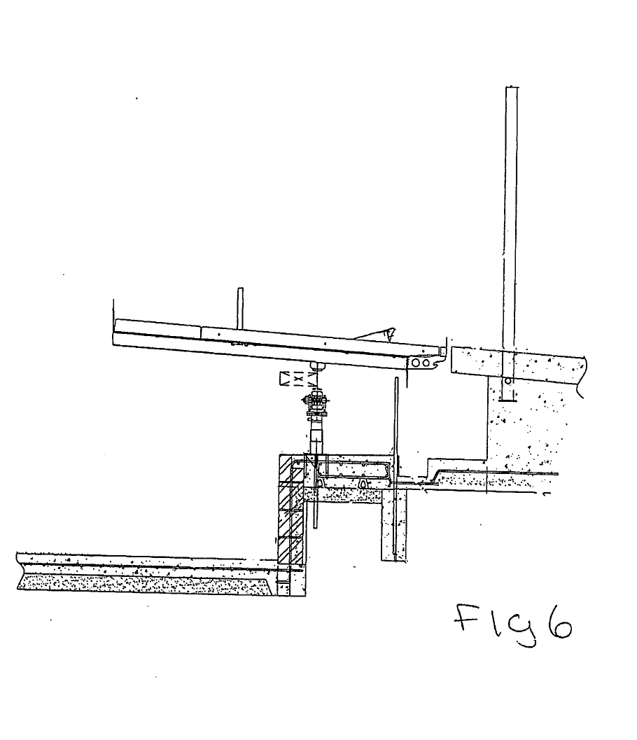

FIG. 5 shows a plan view of the radial rib of an arrangement as in FIG. 4 showing plates fitted thereto which allows fitment of the moulded and other components thereto,

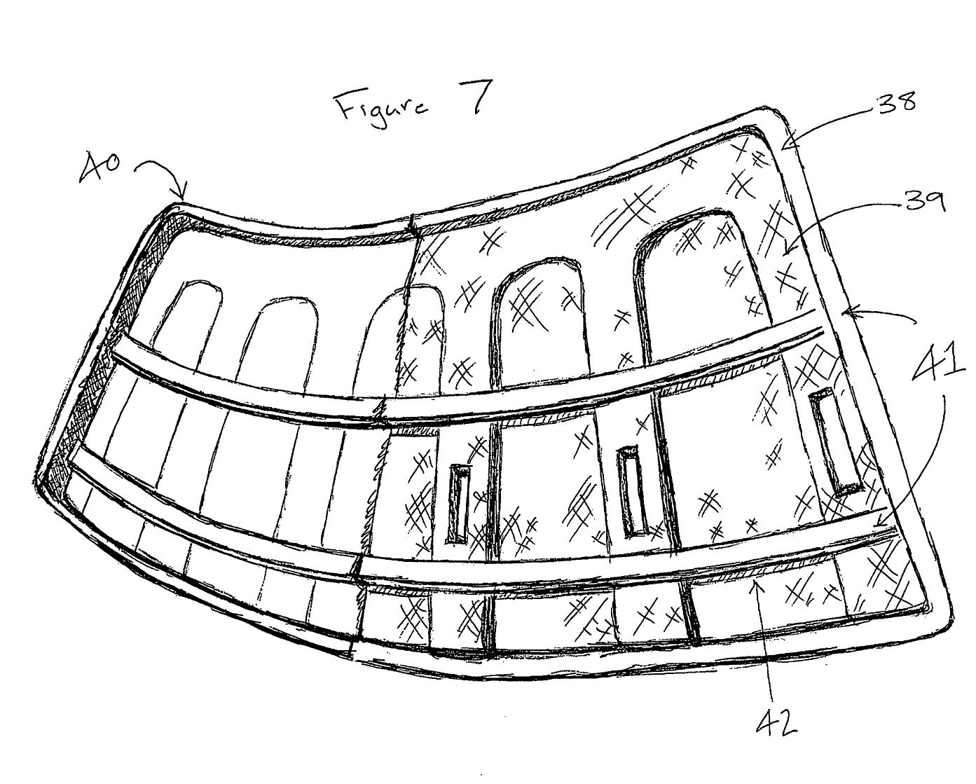

FIG. 6 is a view in elevational section of a facility showing an exterior ramp to the platform or from the platform for entrance and exiting of animals and showing the relationship of the platform to a roof support.

FIG. 7 is a view from the underside of a moulded bail module with a cut away section.

FIG. 1 shows in plan an annular milking platform of 54 bails made up of modules 1 to 9 in series about the annulus. Each of the modules 1 through 9 defines 6 bails.

Other relationships between moulded modular components are nonetheless envisaged as typical examples can range from, say, 20 to 80 bails without necessarily being restricted thereto. Typical examples include as few as 26 bails. Other examples include and are not limited to 50, 54, 60, etc.

For some sizes there may be a desirability to provide two or more types of module that complement to the resulting annulus or substantially annular platform shape.

A preferred module 1 through 9 is preferably formed by resin (e.g. vinylester-epoxy ex-Nuplex) infused moulding (eg, fibreglass) that provides an exoskeleton and structural form about an expanded plastics foam form (or forms) previously placed in mould between glass fibre rovings, mats, textile, etc (e.g. multiple layers of matting such as of Kevlar (ARRAMAT™), and double bias and/or biaxial glassfibre mats (e.g. Owens Corning, Dongil, or others)).

Any suitable surface coating gelcoat (e.g. Nuplex) can be used. It is envisaged that whilst each moduling to be used as a module of the annulus can be in totality a composite material such as fibreglass there is an advantage when moulding such a material, particularly when using resin infusing techniques, to preload the tooling with not only the fibre reinforcement materials for the exoskeletal areas but to lay that about a filler or core material that not only reduces the resin quantities required to infuse about the fibres but also keeps the fibres appropriately positioned for the infusion process. Suitable fillers can be any suitable material rigid or flexible. A core or filler can be of one or more parts most preferably however it is a foam plastics material such as for example foamed polyurethane or foamed polystyrene.

The use of an appropriate choice as the filler or core reduces the weight of the overall moulding. A high density polyurethane foam is preferred.

Preferably as a consequence of the use of a filler or core preferably each bail floor area is underlaid by such a core of material and has by way of example fibreglass above and below of sufficient thickness and strength not withstanding a preferred provision of a depression for placement of a rubber or elastomeric mat for the animals to stand on.

By way of example of metal inclusion see, for example, in FIG. 1 the broken lined radial and arcuate features (ie. within the annular structure as part of the transverse features) 31 and 32 which can be the metallic inclusions. Such inclusions, if tubular as is preferred (eg. box sectioned), can duct utilities or be passageways for utility inclusions (eg. cabling and/or fluid ducting).

Otherwise they can be masses of metal as hereinafter described (eg. 18, 19, 20).

They also provide a metal foundation for screw anchoring. Being metal they also will absorb vibration of a different frequency to the resin matrix.

Preferably shapes vary about the platform as substantially as shown in the attached drawings.

FIG. 2 shows, for a typical annulus, the moulded component 10 with an upper recess 11 into which a matting material, for example reinforced natural or synthetic rubber, can be inserted. Such an arrangement is shown as 11A in FIG. 1. Whilst it can be in mould affixed, preferably to allow ease of replacement it is affixed post moulding.

As shown in the drawings preferably each module 16 or 17 is provided with downwardly moulded ribs with in mould provided receivers for set screws to allow attachment to the substructure eg, via flanges or brackets. These downwardly directed ribs which may include female threaded members therein as shown as 32 in FIG. 4.

The filler of foam plastics material is preferably that region of each module shown as 33 whilst the fibreglass is 34.

A person skilled in the art will appreciate how similar techniques can be used for the walkway providing modules 35. These modules 35 are preferably not used to extend the length of the milking position but rather to allow access to the head of the cow when in the milking condition.

A radial steel or alloy rib 12 of the sub-frame structure is preferably able to run with roller 13 on an annular rail 14 and be confined to be supported thereby in a manner typical of the platforms of Waikato Milking Systems Limited as shown on their website www.waikatomilking.co.nz or as discussed in New Zealand patent specification NZ 551609 of Rotary Platforms NZ Limited, or with pinch rollers.

Shown inwardly of the moulded member 10 is a further moulded member 15 which can be used as an internal walkway, if desired, beyond the bail floor for milking.

FIG. 3 shows the radial ribs 12 and a first module 16 and a second proximate module 17 fitted to be supported by such a sub-frame. Shown are alloy blocks 18, 19 and 20 imbedded in the composite mouldings so as to allow fixing by bolting to flanges 21 and 22 respectively. Examples of such flanges are shown in FIG. 5 with some flanges (eg, 23) being adapted to accommodate fitment of posts 24 whilst others, (eg, 25 and 26) being adapted to allow the bolting of an access port providing fitting 27 for a post 28. Such a fitting 27 serves much the same purpose as disclosed in aforementioned patent specification 551609 of Rotary Platforms Limited.

As can be seen in the drawings each module can have a downwardly directed flange 29 to allow bolting to a like flange of the adjacent module. Provision can be made, for example, at 30 and 31 for post and/or post footing/port fitment.

In the improvement and/or addition to NZ572534, the full content of which is here included by reference, and as shown in FIG. 7, preferably a steel or other metal or metal alloy member able to be machined and having some resilience, yet being self supporting, can be in mould or post mould added to confer additional characteristics. Desirable characteristics may include increased rigidity or an altered response to vibrational excitations.

By way of example only multiple layers as follows can be infused with resin in mould
a gel coat
Kevlar chopped strand mat
glass fibre mat
glass fibre mat
high density foam
glass fibre mat
glass fibre mat
steel beam, block, rib, or the like
glass fibre mat.
   1 or more arcuate steel beams 36 can be positioned to run in a circumferential direction around the moulded bail module as shown in FIG. 7. Reinforcing beams could be positioned in an alternative direction, for example radially. For steel reinforcements added in mould it is preferable to use a box section or RHS, but other sections could be used in the event that reinforcements are added subsequent to moulding. Where the relief of the moulded bail floor does not match the flat surface of the reinforcing member, as shown in FIG. 7, it is preferable to add foam pads 37 or similar to fill the space between the two surfaces.

In other forms the steel can first or subsequently be resin infused after being associated with glass fibre and/or a RTM mat as a spacer in mould.

The glass fibres preferably can be of any suitable g/m³ from 500 to 800 and can be double bias and/or biaxial. Other choices exist besides Kevlar for the aramid or para-aramid fibres.

1. A resin infusion moulded rotary milking platform deck component or module having embedded in the resin matrix
plural layers of glass fibre, and
at least one layer of an aramid or para-aramid strand or fibrous material.

2. The component or module of claim 1 wherein the aramid or para-aramid strand or fibrous material is adjacent the foam plastics core, interposed in glass fibre layers and/or disposed outwardly of the glass fibre layer(s).

3. The component or module of claim 1 wherein in mould or post mould there is an embedding of at least one structural support or other member of a metal.

4. The component or module of claim 3 wherein the member of metal is of elongate form.

5. The component or module of claim 4 wherein the metal of elongate form is either straight, arcuate or of some other shape, and/or has a solid, hollow, box-sectioned or ‘I’ sectioned cross-section.

6. The component or module of claim 4 wherein the metal of elongate form provides transverse and/or radial support of the component or module.

7. The component or module of claim 4 wherein the metal of elongate form provides zonal support for fabrication purposes such as providing an embedded anchor for posts etc.

8. A component or module to provide part of the annular floor structure of a rotary milking platform
wherein at least one metal member supported in mould by fibres and/or RTM form(s) and more expansive layers of fibres have been resin infusion embedded or resin infusion part embedded.

9. A moulded module able to be associated with others on a rotatable support to define a rotary milking platform, the module being moulded at least in part in a composite material yet embedding both at least one structural support or other metallic member and a core of a foam material.

10. The module of claim 9 that defines at least part of the floor and/or mat support for a plurality of bails, and wherein the module includes for its, or each, bail floor it is to fully or in part define, a leg spreading profile or udder spraying site, said leg spreading profile or udder spraying site having been integrally defined by or subsequently added to the module.

11. A rotary milking platform having a rotatable sub-floor frame and a floor defining assembly of infusion moulded platform components or modules of the present invention, said components optionally being fully or partially matted.

12. The platform of claim 11 wherein each module is to define at least part of the floor and/or mat support for a plurality of bails.

13. The platform of claim 11 wherein each module is provided with an inner and outer curved or facetted periphery (preferably circular or a continuous curve) and/or preferably the end peripheries are substantially radially aligned with respect to the axis of rotation of the to be defined rotary milking platforms.

14. An infusion moulded floor module or component to define one or more bail floor of an annular milking platform
wherein at least one metal mass (eg. steel) has been in mould embedded by resin infused fibrous material(s) and/or at least one metal mass (eg. steel) has been post mould embedded by a composite material attaching to an infusion moulded part of the module or component.

15. The module or component of claim 14 wherein the metal mass is a rib.

16. The module or component of claim 14 wherein the metal mass can serve as an anchoring zone for fabrication purposes.

17. A rotary milking platform having an annular platform floor, each bail being or to be matted fully or in part, the floor or sub floor being defined by an assembly of moulded floor defining components, each defining part of, or all of, one or more bail floors and each having a resin matrix reinforced by fibres embedding at least one metallic support or other member.

18. The platform of claim 17 wherein each moulded component is at least in part (and preferably wholly) provided with a composite material surround (eg, as if an exoskeletal surface providing surround about a filler or core providing material and the metallic member(s)).

19. The platform of claim 17 wherein moulding is by a process of infusion moulding with a composite system (eg, a resin system without fibre or a resin system including fibre) into cavities about one or more filler or core providing material (eg, a foam, a blow moulded foam, an expanded form or the like), optionally, in conjunction with in mould positioned fibres and the to be embedded metallic member(s) resulting in the moulding that is at least in part of composite material(s).

20. (canceled)
